(19) United States
(12) Patent Application Publication
(10) Pub. No.: US 2011/0278209 A1
(43) Pub. Date: Nov. 17, 2011

(54) LIQUID PRESSURE MONITORING

(75) Inventors: Dileep Kumar Kana Padinharu, Bangalore (IN); Vasudev Shankar Nilajkar, Bangalore (IN); Nicola Piccirillo, Schenectady, NY (US); Sudhanshu Rai, Bangalore (IN); Chandan Sikdar, Bangalore (IN)

(73) Assignee: GENERAL ELECTRIC COMPANY, Schenectady, NY (US)

(21) Appl. No.: 12/778,529

(22) Filed: May 12, 2010

(51) Int. Cl. B01D 35/143; B01D 35/02

(52) U.S. Cl. 210/90

(57) ABSTRACT

A liquid pressure monitoring system for a circuit of a machine is provided. The system includes a flow meter configured to measure a flow rate of liquid flowing through the circuit, the circuit including a strainer and a cooling section, at least one sensor configured to measure a pressure of at least one portion of the circuit; and a monitoring component for generating an alarm, in response to a value based on the measured pressure exceeding an expected pressure drop, wherein the expected pressure drop is based on the flow rate and at least one flow coefficient.

### BACKGROUND OF THE INVENTION

The subject matter disclosed herein relates to machines and, more particularly, to a liquid pressure monitoring system for a circuit of a machine.

In operation, electrical power generators have stator windings surrounding the rotor that carry a very large current, which increases the temperature of the stator windings and reduces the efficiency of the generator. In order to prevent overheating, generators include a stator cooling system for cooling the windings in the stator.

One such type of stator cooling system is a stator cooling water system. A stator cooling water system requires oxygenated and deionized water to circulate through a network of cooling passages throughout the stator and between the stator windings in order to remove the heat from the windings. To properly cool the stator windings, these cooling passages must remain free from any clogging of the oxygenated water flow. Also, a strainer positioned upstream from the cooling passages is provided to filter any debris in the oxygenated water. This strainer must also be free from any clogging to effectively cool the stator windings.

The design of the stator water cooling system requires that the deionized water remain aerated with a certain level of oxygen content. This level of oxygen is conducive to form a tough, tenacious, and stable cupric oxide film on the inside surfaces of the stator windings. The cupric oxide film protects the copper of the stator windings from erosion and excessive corrosion. In cases where the oxygen level of the deionized water falls below a certain level, the production of cuprous oxide begins. This cuprous oxide layer is much less tenacious than the normal cupric oxide, and, as such, has a tendency to remove the copper strands within the stator windings and these copper strands may enter the water stream. This may potentially clog the strainer and obstruct the oxygenated water flow throughout the remaining portion of the cooling system. This can lead to inefficient cooling of the stator windings, and indirectly decrease the efficiency of the generator.

### BRIEF DESCRIPTION OF THE INVENTION

A first aspect of the invention provides a liquid pressure monitoring system, the system comprising: a flow meter configured to measure a flow rate of liquid flowing through a circuit, the circuit including a strainer and cooling section; at least one sensor configured to measure a pressure of at least one portion of the circuit; and a monitoring component for generating an alarm, in response to a value based on the measured pressure exceeding an expected pressure drop, wherein the expected pressure drop is based on the flow rate and at least one flow coefficient.

A second aspect of the invention provides a liquid-cooled machine comprising: a stator winding surrounding a rotor; a circuit for the stator winding; and a liquid pressure monitoring system for the circuit, the system comprising: a flow meter configured to measure a flow rate of liquid flowing through the circuit, the circuit including a strainer and cooling section; at least one sensor configured to measure a pressure of at least one portion of the circuit; and a monitoring component for generating an alarm, in response to a value based on the measured pressure exceeding an expected pressure drop, wherein the expected pressure drop is based on the flow rate and at least one flow coefficient.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic illustration of an embodiment of a liquid pressure monitoring system in accordance with an aspect of the invention;

FIG. 2 shows a schematic illustration of an embodiment of a liquid pressure monitoring system in accordance with an aspect of the invention;

FIG. 3 shows a schematic illustration of an embodiment of a liquid pressure monitoring system in accordance with an aspect of the invention;

FIG. 4 shows a schematic illustration of an embodiment of a liquid pressure monitoring system in accordance with an aspect of the invention; and

FIG. 5 shows a graph representing the linear relationship between the inlet pressure and the flow rate of a liquid pressure monitoring system according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide for effectively monitoring the pressure drop across a circuit of a liquid-cooled machine. The various embodiments of the present invention described herein are directed to any type of liquid-cooled machine, including, but not limited to an electric generator.

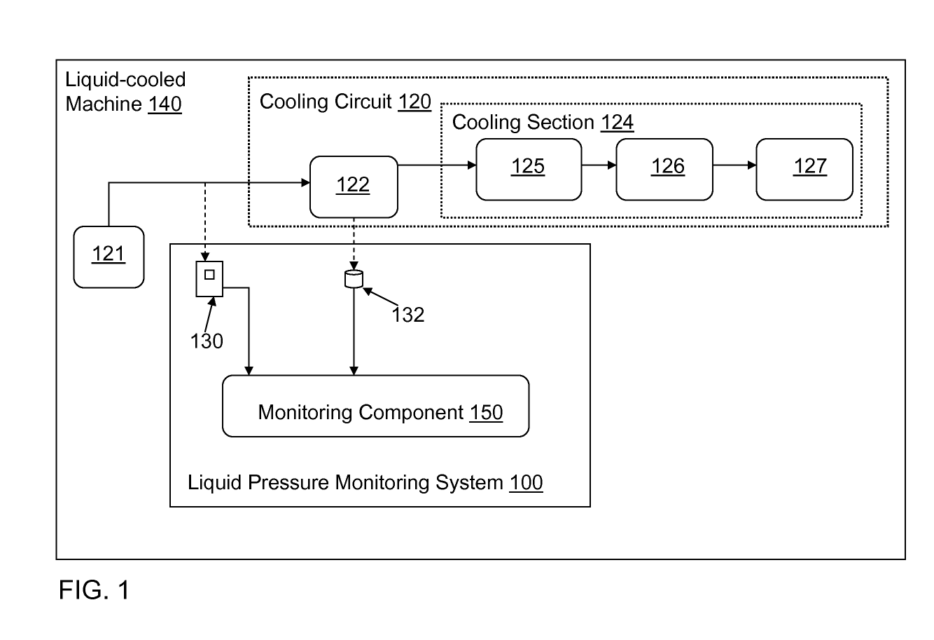

Referring to the drawings, FIGS. 1-4 are schematic illustrations of embodiments of a liquid pressure monitoring system 100, 200, 300, 400, respectively, for a circuit 120 of a liquid-cooled machine 140. Circuit 120 may be a cooling circuit. Cooling circuit 120 may include a strainer 122 and a cooling section 124. For ease of description, FIGS. 1-4 show that cooling section 124 may include liquid-cooled stator windings 125, cooler 126, and sump 127, however, other components not illustrated may be configured to be operable within cooling section 124. A cooling liquid, i.e., oxygenated water, is pumped from pump 121 through strainer 122 and through cooling section 124 in order to remove heat from liquid-cooled stator windings 125. In FIGS. 1-4, a flow meter 130 may be configured to measure a flow rate Q of the cooling liquid flowing through cooling circuit 120. The pressure drop (ΔP) across any portion of cooling circuit 120 is proportional to the square of the flow rate (Q²) of the cooling liquid and some flow coefficient (1/K²), as shown in equation 1:

$$Δ P = \frac{{Q}^{2}}{{K}^{2}} \qquad Equation 1$$

Turning to FIG. 1, liquid pressure monitoring system 100 may include a monitoring component 150, a flow meter 130, and a sensor 132. Monitoring component 150 may be provided for determining whether there is clogging in strainer 122. Sensor 132, such as a differential pressure gauge, may be configured to measure the differential pressure drop ΔP_{measured} across strainer 122 for a flow rate Q measured by flow meter 130. Monitoring component 150 may determine an expected pressure drop ΔP_{expected} across strainer 122 from equation 1, based on flow rate Q measured by flow meter 130, and flow coefficient Kₛ for strainer 122. If ΔP_{measured} exceeds ΔP_{expected}, this may provide an indication of clogging in strainer 122. Monitoring component 150 may be configured to indicate clogging in strainer 122, in response to ΔP_{measured} exceeding ΔP_{expected}. Further, a threshold of how much ΔP_{measured} exceeds ΔP_{expected} may be set for indicating clogging in strainer 122. For example, monitoring component 150 may be set to indicate clogging in strainer 122 if ΔP_{measured} is twice the value of ΔP_{expected}, which would indicate that there is 50% clogging of strainer 122. An indication of clogging may include, but is not limited to, generating an audible alarm, such as a siren, whistle, etc., generating a visual alarm, such as a flashing light, and/or indicating whether strainer 122 must be replaced.

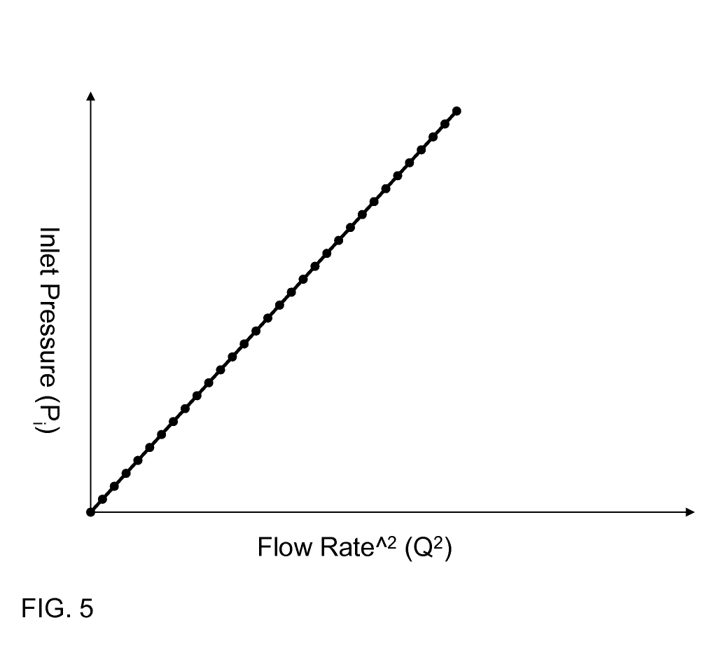

Flow coefficient Kₛ for strainer 122 may be based on the geometry of strainer 122 and provided by a manufacturer of strainer 122. Alternatively, as will be described below with reference to FIG. 5, flow coefficient Kₛ for strainer 122 may be calculated using equation 1 and based on historical data of the measured differential pressure across strainer 122 as a function of the flow rate. The historical data which is used to calculate flow coefficient K is assumed to be for a clean strainer. If the data is not for a clean strainer, then the calculated flow coefficient K is set as a baseline assuming there is no clogging in strainer 122.

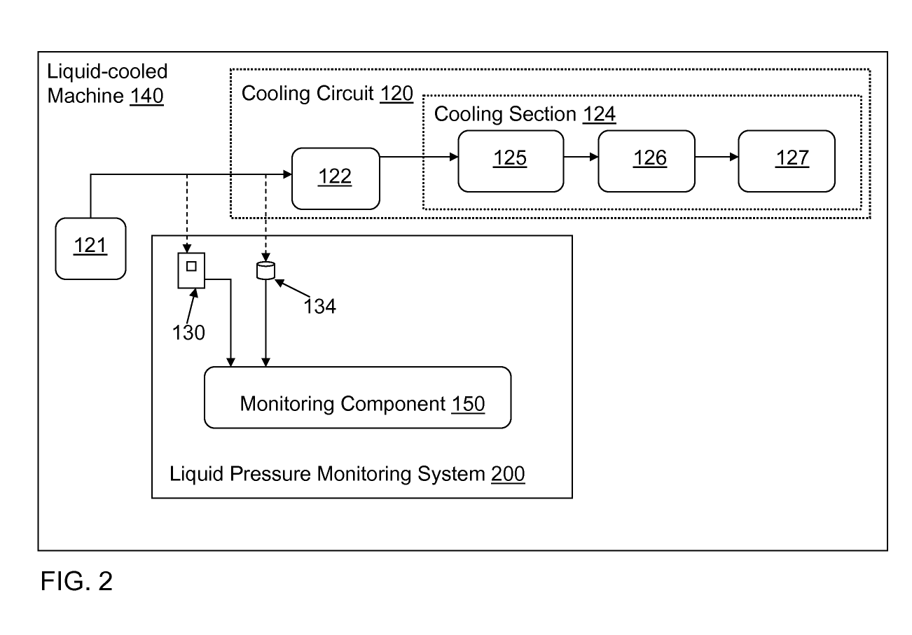

Turning now to FIG. 2, liquid pressure monitoring system 200 may include a monitoring component 150, a flow meter 130, and a sensor 134. In this embodiment, monitoring component 150 may determine whether there is clogging along cooling circuit 120. Sensor 134, such as a pressure sensor, may be configured to measure an inlet pressure Pᵢ of cooling liquid entering strainer 122 for a flow rate Q measured by flow meter 130. An outlet pressure Pₒ of cooling liquid exiting cooling section 124 is calculated based on the historical data of inlet pressure Pᵢ as a function of the square of flow rate Q². ΔP_{measured} is the difference between inlet pressure Pᵢ and outlet pressure Pₒ. Monitoring component 150 may determine an expected pressure drop ΔP_{expected} across cooling circuit 120 from equation 1, based on flow rate Q measured by flow meter 130, and flow coefficient K_{cc} for cooling circuit 120. If ΔP_{measured} exceeds ΔP_{expected}, this may provide an indication of clogging in cooling circuit 120. Monitoring component 150 may be configured to indicate clogging in cooling circuit 120, in response to ΔP_{measured} exceeding ΔP_{expected}. Further, a threshold of how much ΔP_{measured} exceeds ΔP_{expected} may be set for indicating clogging in cooling circuit 120. For example, monitoring component 150 may be set to indicate clogging in cooling circuit 120 if ΔP_{measured} is twice the value of ΔP_{expected}, which would indicate that there is 50% clogging of cooling circuit 120. An indication of clogging may include, but is not limited to, generating an audible alarm, such as a siren, whistle, etc., and/or generating a visual alarm, such as a flashing light.

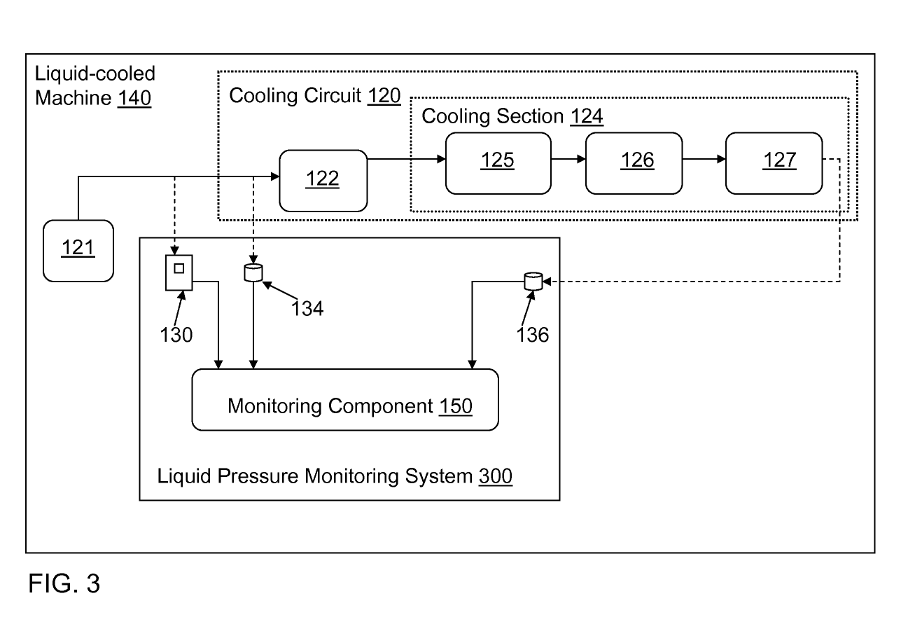

Turning now to FIG. 3, liquid pressure monitoring system 300 may include a monitoring component 150, a flow meter 130, and sensors 134, 136. Monitoring component 150 may determine whether there is clogging along cooling circuit 120. Sensors 134 and 136, such as pressure sensors, may be configured to measure an inlet pressure Pᵢ of cooling liquid entering strainer 122 and an outlet pressure Pₒ of cooling liquid exiting cooling section 124, respectively, for flow rate Q measured by flow meter 130. AP measured is the difference between inlet pressure Pᵢ and outlet pressure Pₒ. Monitoring component 150 may determine an expected pressure drop ΔP_{expected} across cooling circuit 120 from equation 1, based on flow rate Q measured by flow meter 130, and flow coefficient K_{cc} for cooling circuit 120. If ΔP_{measured} exceeds ΔP_{expected}, this may provide an indication of clogging in cooling circuit 120. Monitoring component 150 may be configured to indicate clogging in cooling circuit 120, in response to ΔP_{measured} exceeding ΔP_{expected}. Further, a threshold of how much ΔP_{measured} exceeds ΔP_{expected} may be set for indicating clogging in cooling circuit 120. For example, monitoring component 150 may be set to indicate clogging in cooling circuit 120 if ΔP_{measured} is twice the value of ΔP_{expected}, which would indicate that there is 50% clogging of cooling circuit 120. An indication of clogging may include, but is not limited to, generating an audible alarm, such as a siren, whistle, etc., and/or generating a visual alarm, such as a flashing light.

Flow coefficient K_{cc} for cooling circuit 120 and flow coefficient Kₛ for strainer 122 may be based the historical data of inlet pressure Pᵢ and outlet pressure Pₒ as a function of the square of flow rate Q². Turning to FIG. 5, the relationship between inlet pressure Pᵢ and the square of flow rate Q² is linear according to the following equation (which is a rearrangement of equation 1):

$${P}_{i} = \frac{{Q}^{2}}{{K}_{cc}^{2}} + {P}_{o} \qquad Equation 2$$

If several data points are available for inlet pressure Pᵢ, and the square of flow rate Q², the plotting curve, as shown in FIG. 5, may provide the value of flow coefficient K_{cc} and outlet pressure Pₒ for cooling circuit 120. The historical data which is used to calculate the flow coefficient is assumed to be for a clean cooling circuit. If the data is not for a clean circuit, then the calculated flow coefficient is set as a baseline assuming there is no clogging in the cooling circuit 120. Although equation 2 is shown with flow coefficient K_{cc} for cooling circuit 120, flow coefficient Kₛ for strainer 122 may also be determined based on historical data, using equation 2.

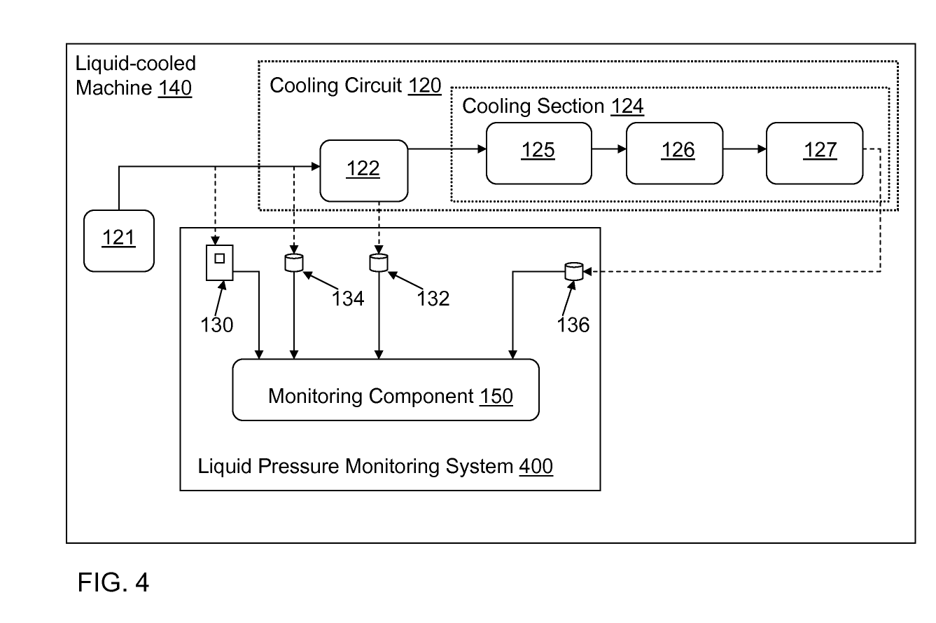

Turning now to FIG. 4, liquid pressure monitoring system 400 may include a monitoring component 150, a flow meter 130, and sensors 132, 134, 136. Monitoring component 150 may be provided for determining whether there is clogging in strainer 122 or in cooling section 124. That is, monitoring component 150 may determine the possibility of clogging in strainer 122 and cooling section 124 separately. In this embodiment, similar to the embodiment in FIG. 1, liquid pressure monitoring system 400 may include sensor 132 configured to measure the differential pressure drop ΔP_{measured}_{_{—}}ₛₜᵣₐᵢₙₑᵣ across strainer 122. Monitoring component 150 may determine an expected pressure drop ΔP_{expected}_{_{—}}ₛₜᵣₐᵢₙₑᵣ across strainer 122 from equation 1, based on flow rate Q measured by flow meter 130, and flow coefficient Kₛ for strainer 122. If ΔP_{measured}_{_{—}}ₛₜᵣₐᵢₙₑᵣ exceeds ΔP_{expected}_{_{—}}ₛₜᵣₐᵢₙₑᵣ, monitoring component 150 may provide an indication of clogging in strainer 122. Monitoring component 150 may be configured to indicate clogging in strainer 122, in response to ΔP_{measured}_{_{—}}ₛₜᵣₐᵢₙₑᵣ exceeding ΔP_{expected}_{_{—}}ₛₜᵣₐᵢₙₑᵣ. An indication of clogging may include, but is not limited to, generating an audible alarm, such as a siren, whistle, etc., and/or generating a visual alarm, such as a flashing light.

Liquid pressure monitoring system 400 may also include sensors 134 and 136 configured to measure inlet pressure Pᵢ of cooling liquid entering strainer 122 and an outlet pressure Pₒ of cooling liquid exiting cooling section 124, respectively. Monitoring component 150 may determine the measured pressure drop ΔP_{measured}_{_{—}}_{coolingsection} across cooling section 124 by determining the difference between inlet pressure Pᵢ and outlet pressure Pₒ (which is the pressure drop across the cooling circuit 120, as mentioned above with reference to FIGS. 2 and 3), and subtracting the differential pressure drop ΔP_{measured}_{_{—}}ₛₜᵣₐᵢₙₑᵣ across strainer 122. This determination of measured pressure drop ΔP_{measured}_{_{—}}_{coolingsection} across cooling section 124 is illustrated in equation 3 below:

ΔP_{measured}_{_{—}}_{cooling section}=(Pᵢ−Pₒ)−ΔP_{measured}_{_{—}}ₛₜᵣₐᵢₙₑᵣ Equation 3

Monitoring component 150 may also determine the expected pressure drop ΔP_{expected}_{_{—}}_{coolingsection} across cooling section 124 by determining the difference between the expected pressure drop ΔP_{expected}_{_{—}}ₛₜᵣₐᵢₙₑᵣ across strainer 122, as a function of flow rate Q and flow coefficient Kₛ for strainer 122, and the expected pressure drop ΔP_{expected}_{_{—}}_{cc} across cooling circuit 120, as a function of flow rate Q and flow coefficient K_{cc} for cooling circuit 120. This determination of expected pressure drop ΔP_{expected}_{_{—}}_{coolingsection} across cooling section 124 is illustrated in equation 4 below:

$$Δ {P}_{expected\_cooling section} = Δ {P}_{expected\_strainer} - Δ {P}_{expected\_cc} = \frac{{Q}^{2}}{{K}_{s}^{2}} - \frac{{Q}^{2}}{{K}_{cc}^{2}} \qquad Equation 4$$

If ΔP_{measured}_{_{—}}_{coolingsection} exceeds ΔP_{expected}_{_{—}}_{expected coolingsection}, this may provide an indication of clogging in cooling section 124. Monitoring component 150 may be configured to indicate clogging, in response to ΔP_{measured}_{_{—}}_{coolingsection} exceeding ΔP_{expected}_{_{—}}_{coolingsection}. An indication of clogging may include, but is not limited to, generating an audible alarm, such as a siren, whistle, etc., and/or generating a visual alarm, such as a flashing light.

Liquid pressure monitoring system 100, 200, 300, 400 may be embodied take the form of an entirely hardware embodiment, an entirely software embodiment (including firmware, resident software, micro-code, etc.) or an embodiment combining software and hardware aspects that may all generally be referred to herein as a “circuit,” “module” or “system,” wherein the technical effect is to provide liquid pressure monitoring as described above. Furthermore, system 100, 200, 300, 400 may take the form of a computer program product embodied in any tangible medium of expression having computer-usable program code embodied in the medium. In this case, the computer program instructions of system 100, 200, 300, 400 may be loaded onto a computer or other programmable data processing apparatus, such as the overall control system (not shown) for liquid-cooled machine 140, to cause a series of operational steps to be performed on the computer or other programmable apparatus to produce a computer implemented process such that the instructions which execute on the computer or other programmable apparatus provide processes for implementing the functions/acts specified herein.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the generator's computer controller, partly on the controller, as a stand-alone software package, partly on the controller and partly on a remote computer or entirely on the remote computer or server. In the latter scenario, the remote computer may be connected to the generator's computer controller through any type of network, including a local area network (LAN) or a wide area network (WAN), or the connection may be made to an external computer (for example, through the Internet using an Internet Service Provider).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A liquid pressure monitoring system, the system comprising:
a flow meter configured to measure a flow rate of liquid flowing through a circuit, the circuit including a strainer and a cooling section;
a first sensor configured to measure a pressure drop across the strainer;
a second sensor configured to measure an inlet pressure of the liquid flowing into the circuit;
a third sensor configured to measure an outlet pressure of the liquid flowing out of the circuit; and
a monitoring component for indicating-clogging in the cooling section of the circuit, in response to a pressure drop across the cooling section exceeding an expected pressure drop for the cooling section, wherein the pressure drop across the cooling section is based on the measured pressures from the first, second, and third sensors, and the expected pressure drop for the cooling section is based on the flow rate, a flow coefficient of the strainer, and a flow coefficient for the cooling section.

2. The system of claim 1, wherein the first sensor includes a pressure gauge to measure the pressure drop across the strainer.

3. (canceled)

4. The system of claim 2, wherein the strainer flow coefficient is based a geometry of the strainer.

5. The system of claim 2, wherein the strainer flow coefficient is based on historical data of the measured pressure drop across the strainer as a function of the flow rate.

6. The system of claim 1, wherein the monitoring component further indicates clogging in the strainer, in response to the measured pressure drop across the strainer exceeding an expected pressure drop across the strainer, wherein the expected pressure drop across the strainer is based on the flow rate and the strainer flow coefficient.

7. The system of claim 6, wherein the monitoring component generates an alarm to indicate clogging in the cooling section.

8. The system of claim 1, wherein the cooling section includes a plurality of liquid-cooled stator windings, a cooler, and a sump.

9. (canceled)

10. The system of claim 1, wherein the circuit is a cooling circuit.

11. A liquid-cooled machine comprising:
a stator winding surrounding a rotor;
a circuit for the stator winding; and
a liquid pressure monitoring system for the circuit, the system comprising:
a flow meter configured to measure a flow rate of liquid flowing through the circuit, the circuit including a strainer and a cooling section;
a first sensor configured to measure a pressure drop across the strainer;
a second sensor configured to measure an inlet pressure of the liquid flowing into the circuit;
a third sensor configured to measure an outlet pressure of the liquid flowing out of the circuit; and
a monitoring component for indicating-clogging in the cooling section of the circuit, in response to a pressure drop across the cooling section exceeding an expected pressure drop for the cooling section, wherein the pressure drop across the cooling section is based on the measured pressures from the first, second, and third sensors, and the expected pressure drop for the cooling section is based on the flow rate, a flow coefficient of the strainer, and a flow coefficient for the cooling section.

12. The machine of claim 11, wherein the one first sensor includes a pressure gauge to measure the pressure drop across the strainer and the at least one flow coefficient includes a strainer flow coefficient.

13. (canceled)

14. The machine of claim 12, wherein the strainer flow coefficient is based a geometry of the strainer.

15. The machine of claim 12, wherein the strainer flow coefficient is based on historical data of the measured pressure drop across the strainer as a function of the flow rate.

16. The machine of claim 11, wherein the monitoring component further indicates clogging in the strainer, in response to the measured pressure drop across the strainer exceeding an expected pressure drop across the strainer, wherein the expected pressure drop across the strainer is based on the flow rate and the strainer flow coefficient.

17. The machine of claim 16, wherein the monitoring component generates an alarm to indicate clogging in the cooling section.

18. The machine of claim 11, wherein the cooling section includes a plurality of liquid-cooled stator windings, a cooler, and a sump.

19. (canceled)

20. The machine of claim 11, wherein the circuit is a cooling circuit.
